(19) United States
(12) Patent Application Publication
(10) Pub. No.: US 2012/0227397 A1
(43) Pub. Date: Sep. 13, 2012

(54) GASEOUS FUEL-POWERED ENGINE SYSTEM HAVING TURBO-COMPOUNDING

(76) Inventors: Martin L. WILLI, Dunlap, IL (US); Shriram Vijayaraghavan, Peoria, IL (US); David T. Montgomery, Edelstein, IL (US)

(21) Appl. No.: 13/045,066

(22) Filed: Mar. 10, 2011

(51) Int. Cl. F02B 37/00

(52) U.S. Cl. 60/605.1

(57) ABSTRACT

An engine system is disclosed. The engine system may have an engine configured to receive air and a gaseous fuel, and combust a mixture of the air and gaseous fuel to generate a power output and a flow of exhaust. The engine system may also have at least one power turbine driven by the flow of exhaust to compound the power output of the engine. The engine may employ the Miller Cycle during compounding by the at least one power turbine.

### TECHNICAL FIELD

The present disclosure relates generally to a gaseous fuel-powered engine system and, more particularly, to a gaseous fuel-powered engine system having turbo-compounding.

### BACKGROUND

Engines combust a mixture of fuel and air to generate a mechanical power output and a flow of exhaust. The amount of mechanical power produced by the engine through the combustion process is directly related to an amount of air and fuel that can be provided into the engine. For this reason, engines are often equipped with one or more turbochargers that are driven by exhaust to compress combustion air entering the engine. By forcing air into the engine, more air becomes available for combustion than could otherwise be drawn into the engine by motion of the engine's pistons. This increased supply of air allows for increased fueling, resulting in an increased amount of mechanical power produced by the engine. A turbocharged engine typically produces more mechanical power than the same engine without turbocharging.

Unfortunately, turbochargers do not remove all of the energy contained within an engine's exhaust prior to the exhaust being discharged to the atmosphere. Thus, upon discharge to the atmosphere, some amount of energy may still be wasted in the form of heat and/or pressure. If this energy could be recuperated, efficiency of the engine could be improved.

One attempt to recuperate exhaust energy is disclosed in U.S. Patent Publication No. 2010/0148518 (the '518 publication) of Algrain that published on Jun. 17, 2010. Specifically, the '518 publication discloses an engine, for example a gaseous fuel-powered engine, that together with a main generator forms a part of a generator set that functions to generate electricity directed to an external load. The engine includes at least one main turbocharger having a compressor connected to and driven by a turbine. The turbine is oversized relative to the compressor and provides a greater mechanical power output than consumed by the compressor to pressurize combustion air. The extra mechanical power output from the turbine is used to drive an auxiliary generator that generates additional electricity directed to the external load. During operation of the generator set, electrical synchronizing and transforming is performed to produce a common electrical power supply. In this manner, the gas engine utilizes turbo-compounding to improve an efficiency of the gas engine.

Although the '518 publication describes utilizing turbo-compounding to improve an engine's efficiency, the configuration may be problematic when applied to a conventional gaseous fuel-powered engine. Specifically, turbo-compounding increases the backpressure of an engine and, when applied to a conventional gaseous fuel-powered engine, the increased backpressure can cause detonation and associated instabilities within the engine.

The engine system of the present disclosure addresses one or more of the problems set forth above and/or other problems of the prior art.

### SUMMARY

In one aspect, the present disclosure is directed toward an engine system. The engine system may include an engine configured to receive air and a gaseous fuel, and combust a mixture of the air and gaseous fuel to generate a power output and a flow of exhaust. The engine system may also include at least one power turbine driven by the flow of exhaust to compound the power output of the engine. The engine may employ the Miller Cycle during compounding by the at least one power turbine.

In another aspect, the present disclosure is directed toward a method of generating power. The method may include directing a mixture of gaseous fuel and air into an engine, and combusting the mixture to generate a power output and a flow of exhaust. The method may also include drawing energy from the flow of exhaust to compound the power output, and employing the Miller Cycle when compounding the power output.

### BRIEF DESCRIPTION OF THE DRAWING

FIG. 1 is a pictorial illustration of one exemplary disclosed engine system; and

FIG. 2 is a graph illustrating an exemplary operation performed by the engine system of FIG. 1.

### DETAILED DESCRIPTION

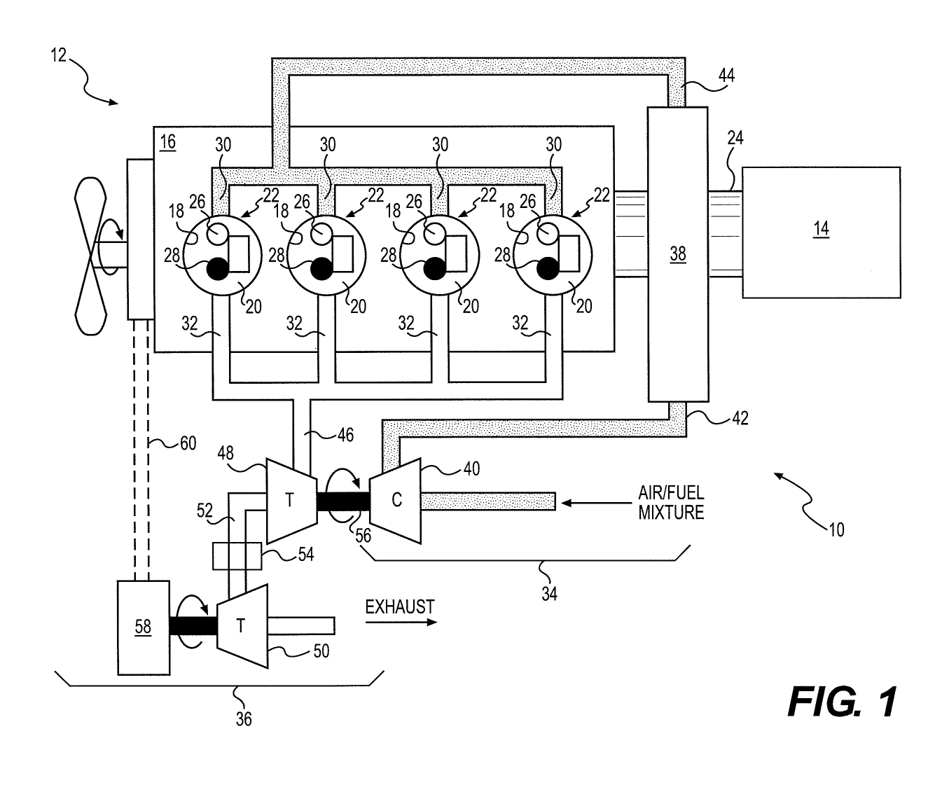

FIG. 1 illustrates an exemplary engine system 10 consistent with certain disclosed embodiments. For the purposes of this disclosure, engine system 10 is depicted and described as including a spark-ignited, gaseous-fueled, internal combustion engine 12 configured to drive a load 14. Load 14 may include any type of power consuming system or device that is connected to receive a mechanical power output from engine 12 and utilize the output to perform a specialized task. In one embodiment, load 14 may be a generator located at a mobile or stationary power plant and configured to produce an electrical output (i.e., engine 12 and load 14 may together form a mobile or stationary generator set). In other embodiments, load 14 may be a transmission of a mobile machine, a stationary pump, or another similar device configured to transmit and/or produce a mechanical or hydraulic output.

Engine 12 may include an engine block 16 that at least partially defines one or more cylinders 18, and a piston 20 disposed within each cylinder 18 to form a main combustion chamber 22. It is contemplated that engine system 10 may include any number of combustion chambers 22 and that combustion chambers 22 may be disposed in an “in-line” configuration, a “V” configuration, or in any other conventional configuration. It is also contemplated that, in some embodiments, engine 12 may include a pre-combustion chamber (not shown) in communication with each main combustion chamber 22, if desired, to facilitate ignition during some lean burn operations.

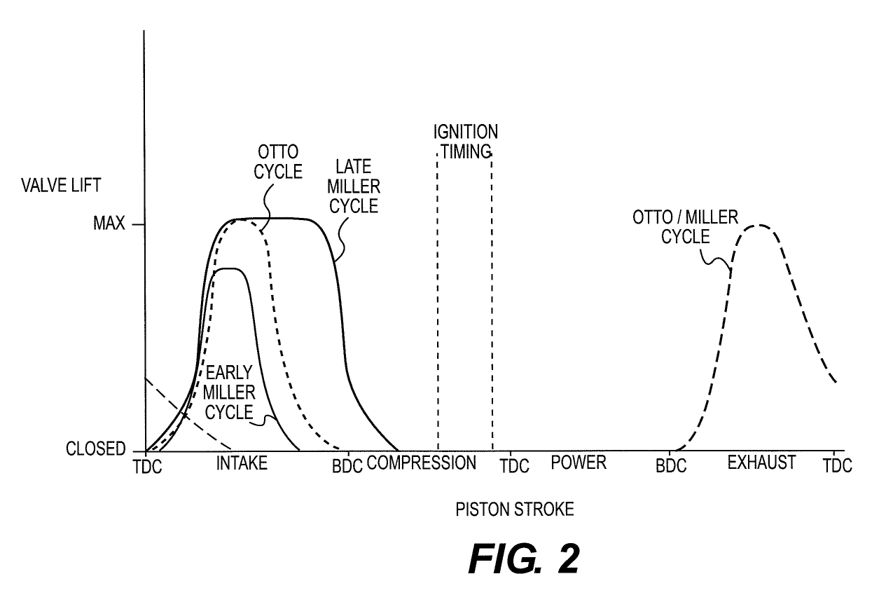

Each piston 20 may be configured to reciprocate between a bottom-dead-center (BDC) or lower-most position within cylinder 18, and a top-dead-center (TDC) or upper-most position within cylinder 18. In particular, piston 20 may be pivotally coupled to a throw of a crankshaft 24 by way of a connecting rod (not shown). Crankshaft 24 of engine 12 may be journaled within engine block 16 and each piston 20 coupled to crankshaft 24 such that a sliding motion of each piston 20 within each cylinder 18 results in a rotation of crankshaft 24. Similarly, a rotation of crankshaft 24 may result in a reciprocating motion of piston 20. As crankshaft 24 rotates through about 180 degrees, piston 20 may move through one full stroke between BDC and TDC. As shown in FIG. 2, engine 12 may be a four-stroke engine, wherein a complete cycle includes an intake stroke (TDC to BDC), a compression stroke (BDC to TDC), a power stroke (TDC to BDC), and an exhaust stroke (BDC to TDC). It is contemplated, however, that engine 12 may alternatively embody a two-stroke engine, if desired, wherein a complete cycle includes a compression/exhaust stroke (BDC to TDC) and a power/exhaust/intake stroke (TDC to BDC). Accordingly, the reciprocating motion of piston 20 during particular strokes may be defined in terms of angles of crankshaft rotation relative to the TDC and BDC positions, for example in terms of a number of degrees before TDC (BTDC), before BDC (BBDC), after TDC (ATDC), and after BDC (ABDC), as will be described in more detail below. Load 14 may be connected to and driven by one end of crankshaft 24.

Engine 12 may also include a plurality of gas exchange valves associated with each cylinder 18 and configured to meter air and fuel into and exhaust out of combustion chambers 22. Specifically, engine 12 may include at least one intake valve 26 and at least one exhaust valve 28 associated with each cylinder 18. FIG. 2 illustrates intake valve 26 as being configured to normally allow air or an air and fuel mixture to flow through a respective intake port 30 (referring to FIG. 1) and into a corresponding combustion chamber 22 during a portion of the intake and/or compression strokes of piston 20. Exhaust valve 28 may be configured to normally allow exhaust to exit from the corresponding combustion chamber 22 through a respective exhaust port 32 during a portion of the power and/or exhaust strokes of piston 20.

Each of intake and exhaust valves 26, 28 may be actuated in any conventional way to move or “lift” and thereby open the respective port 30, 32 in a cyclical manner. For example, intake and exhaust valves 26, 28 may be normally lifted by way of an engine cam (not shown) that is rotatingly driven by crankshaft 24, by way of a hydraulic actuator (not shown), by way of an electronic actuator (not shown), or in any other manner. During normal operation of engine 12, intake and exhaust valves 26, 28 may be lifted in a predefined cycle related to the motion of the associated piston 20 and rotation of crankshaft 24. It is contemplated, however, that a variable valve actuator (not shown) may additionally or alternatively be associated with intake and/or exhaust valves 26, 28 to selectively interrupt the cyclical movements described above (e.g., to adjust an opening time, a closing time, and/or a lift height) and thereby implement particular temporary operations of engine 12.

As shown by the solid curve in FIG. 2, engine 12 may normally or selectively employ a late Miller Cycle during operation to reduce NO_{X} formation and increase efficiency. For the purposes of this disclosure, the late Miller Cycle may be defined as an engine cycle during which intake valve 26 is held open significantly longer than normally associated with the conventional Otto Cycle (shown in the dashed curve associated with the intake stroke of FIG. 2). For example, during the late Miller Cycle, intake valve 26 may be held open until about 30-90° ABDC of the compression stroke, as compared to only about 10° before or after BDC in a conventional engine. As piston 20 moves upwards during the compression stroke of the late Miller Cycle, about 5-20% of the air or air and fuel mixture drawn into combustion chamber 22 during the previous intake stroke (i.e., air that would normally be retained within combustion chamber 22 during operation in the conventional Otto Cycle) may be expelled back out the still-open intake valve 26. Accordingly, holding intake valve 26 open during a portion of the compression stroke may result in less of the air or air and fuel mixture within combustion chamber 22 and, subsequently, less work performed by piston 20 to compress the air or air and fuel mixture. The lower amount of compression work performed by piston 20 may equate to a lower pre-combustion temperature within combustion chamber 22, which may allow for spark-ignition timing to be advanced without the risk of detonation or damaging cylinder pressures. The lower pre-combustion temperatures and advanced timing may result in reduced NOX formation and increased efficiency, respectively. In the disclosed embodiment, spark-ignition timing may be advanced to about 40-20° BTDC of the compression stroke, as compared to the more conventional spark-ignition timing of about 30-10° BTDC.

FIG. 2 also illustrates an alternative embodiment, where engine 12 normally or selectively employs an early Miller Cycle during operation to reduce NO_{X} formation and increase efficiency. For the purposes of this disclosure, the early Miller Cycle may be defined as an engine cycle during which intake valve 26 is closed significantly earlier than normally associated with the conventional Otto Cycle. For example, during the early Miller Cycle, intake valve 26 may be closed at about 100-180° ATDC of the intake stroke, as compared to only about 10° before or after BDC of the intake stroke in a conventional engine. As piston 20 moves downwards during the intake stroke of the early Miller Cycle, about 5-20% less of the air or air and fuel mixture may be drawn into combustion chamber 22 (i.e., air that would normally be retained within combustion chamber 22 during operation in the conventional Otto Cycle) before intake valve 26 closes. Accordingly, closing intake valve 26 early during a portion of the intake stroke may result in less of the air or air and fuel mixture within combustion chamber 22 and, subsequently, less work performed by piston 20 to compress the air or air and fuel mixture.

Engine 12 may include multiple different subsystems that cooperate to facilitate combustion within cylinders 18. The subsystems of engine 12 may include, among others, an air induction system 34, and an exhaust system 36 (referring back to FIG. 1). Air induction system 34 may be configured to supply charge air or a mixture of air and fuel to engine 12 for subsequent combustion. Exhaust system 36 may be configured to treat and discharge byproducts of the combustion process from engine 12 to the atmosphere.

Air induction system 34 may include multiple components that cooperate to condition and introduce compressed air and fuel into combustion chambers 22. For example, air induction system 34 may include an air cooler 38 located downstream of one or more compressors 40. Air cooler 38 may be connected to compressors 40 by way of a passage 42 and to intake ports 30 by way of a passage 44. Compressors 40 may be configured to pressurize a mixture of air and gaseous fuel, for example, natural gas, propane, or methane, that is directed through cooler 38 and into engine 12 via passages 42, 44 and intake ports 30. In the disclosed embodiment, the mixture of air and fuel supplied to compressors 40 may be lean (i.e., have an actual air-to-fuel ratio greater than a stoichiometric air-to-fuel ratio) for a majority of an operational time of engine 12 to help lower an amount of NO_{X} emitted to the atmosphere. It is contemplated that air induction system 34 may include different or additional components than described above such as, for example, a throttle valve, filtering components, compressor bypass components, and other components known in the art.

Exhaust system 36 may include multiple components that condition and direct exhaust from combustion chambers 22 to the atmosphere. For example, exhaust system 36 may include an exhaust passage 46, one or more exhaust turbines 48 driven by exhaust flowing through passage 46, and a power turbine 50 located downstream of exhaust turbine 48 and connected to exhaust turbine 48 by way of a passage 52. Exhaust passage 46 may fluidly connect exhaust ports 32 associated with combustion chambers 22 to exhaust turbine 48. In some embodiments, one or more aftertreatment components 54, for example oxidation catalysts, filters, traps, adsorbers, absorbers, reduction catalysts, scrubbers, exhaust gas recirculation circuits, etc., may be disposed within or connected to passage 52 at a location where pressures and/or temperatures are within a desired activation and/or efficiency range of the components (e.g., between exhaust turbine 48 and power turbine 50). It is contemplated that exhaust system 36 may include different or additional components than described above such as, for example, bypass components, an exhaust compression or restriction brake, an attenuation device, and other known components, if desired.

Exhaust turbine 48 may be configured to receive exhaust discharged from combustion chambers 22, and may be connected to one or more compressors 40 of air induction system 34 by way of a common shaft 56 to form a turbocharger. As the hot exhaust gases exiting engine 12 move through exhaust turbine 48 and expand against vanes (not shown) thereof, exhaust turbine 48 may draw heat and pressure energy from the exhaust and use the energy to rotate and drive the connected compressor 40 to pressurize the mixture of inlet air and gaseous fuel. Exhaust turbine 48 may have any number of inlet volutes, embody a fixed or variable geometry turbine, or include a combination of fixed and variable geometry technology.

Power turbine 50 may be configured to receive exhaust discharged from exhaust turbine 48, and may be connected to compound a power output of engine 12. For the purposes of this disclosure, the compounding performed by power turbine 50 may be defined as the direct adding of mechanical or electrical power by power turbine 50 to the main output of engine 12. In other words, during compounding, power turbine 50 acts as a mechanical or electrical power producing device that functions in parallel with the main output of engine 12 to add to the main output. In the disclosed embodiment, power turbine 50 may be mechanically connected to an end of crankshaft 24 opposite load 14, for example by way of a gear reduction box 58, a chain 60, a belt (not shown), a hydraulic circuit (not shown), a combination of these technologies, or in another suitable manner. As the hot exhaust gases exiting exhaust turbine 48 move through power turbine 50 and expand against vanes (not shown) thereof, power turbine 50 may draw heat and pressure energy from the exhaust and use the energy to rotate and drive crankshaft 24, thereby compounding the output of engine 12. It is contemplated that power turbine 50 may alternatively be configured to drive an auxiliary generator, if desired, and compound the output of engine 12 by producing electrical power that supplements a mechanical and/or electrical power output of engine 12 and/or load 14. Power turbine 50 may have any number of inlet volutes, embody a fixed or variable geometry turbine, or include a combination of fixed and variable geometry technology. In one embodiment, the power output of power turbine 50 may account for about 5-25% of a total output of engine system 10.

### INDUSTRIAL APPLICABILITY

The disclosed engine system may have application in any stationary or mobile platform where efficiency and exhaust emissions may be concerns. The disclosed engine system may improve efficiency and lower exhaust emissions by implementing turbo-compounding of a lean-burn, gaseous-fueled engine. Operation of engine system 10 will now be explained.

Referring to FIG. 1, air induction system 34 may pressurize and force a lean mixture of air and fuel into combustion chambers 22 of engine system 10 for subsequent combustion. The fuel and air mixture may be combusted by engine system 10 to produce a mechanical work output and an exhaust flow of hot gases. The exhaust flow may be directed through exhaust turbine 48 and aftertreatment components 54 toward power turbine 50, where power turbine 50 may draw energy from the exhaust and compound the output of engine 12. After the removal of exhaust energy by power turbine 50, the exhaust may pass to the atmosphere.

Historically, turbo-compounding of a spark-ignited, gaseous fuel-powered engine was not possible, as the turbo-compounding resulted in excessive exhaust backpressures. These high exhaust backpressures caused a significant amount of high-temperature exhaust and unburned hydrocarbons to remain within combustion chambers 22 following an exhaust stroke. Although the trapped hydrocarbons may help to improve fuel efficiency through additional combustion during a subsequent cycle and thereby also lower emissions of the engine (e.g., lower NO_{X} and hydrocarbon emission), the residual heat and hydrocarbons also elevate pressures and temperatures within combustion chambers 22 to levels sufficient to cause detonation of a newly received air/fuel mixture during a subsequent combustion cycle. In the disclosed embodiment, however, engine system 10 may employ the Miller Cycle (late or early) during the turbo-compounding. It is contemplated that implementation of turbo-compounding and/or the Miller Cycle may be continuous throughout the operation of engine system 10 or, alternatively, only selectively implemented as desired via control of VGT features and/or variable valve actuation.

As described above, by employing the Miller Cycle, pre-combustion temperatures and pressures within combustion chambers 22 may be lowered to below detonation-inducing levels of the lean air/fuel mixture, even with the increase in temperature, pressure, and residual hydrocarbons caused by turbo-compounding. Accordingly, the disclosed engine system may benefit from improved efficiencies and reduced NO_{X} associated with the Miller Cycle, as well as with improved efficiency and reduced levels of unburned hydrocarbons associated with turbo-compounding. Emissions can be improved even further through the use of lean burn strategies.

It will be apparent to those skilled in the art that various modifications and variations can be made in the disclosed engine system without departing from the scope of the disclosure. Other embodiments of the disclosed engine system will be apparent to those skilled in the art from consideration of the specification and practice of the engine system disclosed herein. It is intended that the specification and examples be considered as exemplary only, with a true scope of the disclosure being indicated by the following claims and their equivalents.

What is claimed is:

1. An engine system, comprising:
an engine configured to receive air and a gaseous fuel, and combust a mixture of the air and gaseous fuel to generate a power output and a flow of exhaust; and
at least one power turbine driven by the flow of exhaust to compound the power output of the engine,
wherein the engine employs the Miller Cycle during compounding by the at least one power turbine.

2. The engine system of claim 1, wherein the air and gaseous fuel is mixed prior to entering a cylinder of the engine.

3. The engine system of claim 2, wherein the mixture is spark-ignited within the engine.

4. The engine system of claim 3, wherein the mixture is spark-ignited within a main combustion chamber of the engine.

5. The engine system of claim 2, further including:
a compressor configured to pressurize the mixture; and
an exhaust turbine driven by the flow of exhaust to drive the compressor.

6. The engine system of claim 5, wherein the power turbine is located downstream of the exhaust turbine.

7. The engine system of claim 6, further including at least one aftertreatment component located between the exhaust and power turbines.

8. The engine system of claim 2, wherein the mixture is lean during a majority of an operational time.

9. The engine system of claim 1, wherein:
the engine includes an engine block at least partially defining a cylinder, a piston disposed within the cylinder to form a combustion chamber, and at least one intake valve associated with the combustion chamber; and
the engine employs the Miller Cycle by closing the at least one intake late during a compression stroke of the piston at about 30-90° of crank angle after the piston passes through a bottom-dead-center position.

10. The engine system of claim 9, wherein the mixture is spark ignited at about 40-20° of crank angle before the piston passes through a top-dead-center position during the compression stroke.

11. The engine system of claim 1, wherein:
the engine includes an engine block at least partially defining a cylinder, a piston disposed within the cylinder to form a combustion chamber, and at least one intake valve associated with the combustion chamber; and
the engine employs the Miller Cycle by closing the at least one intake early during an intake stroke of the piston at about 100-180° of crank angle after the piston passes through a top-dead-center position.

12. The engine system of claim 1, wherein:
the engine includes a crankshaft driven by combustion of the mixture; and
the at least one power turbine is mechanically connected to drive the crankshaft.

13. The engine system of claim 12, further including a generator driven by the crankshaft, wherein the at least one power turbine is connected to the crankshaft at an end opposite the generator.

14. An engine system comprising:
an engine that is spark-ignited and powered by gaseous-fuel to produce a power output and a flow of exhaust, the engine having a combustion chamber and an intake valve associated with the combustion chamber;
a compressor configured to compress a lean mixture of the gaseous fuel and air directed into the engine;
an exhaust turbine driven by the flow of exhaust from the engine to rotate the compressor; and
a power turbine located downstream of the exhaust turbine and driven by the flow of exhaust to compound the power output,
wherein:
the engine employs the Miller Cycle by causing the intake valve to close at about 30-90° of crank angle after an associated piston passes through a bottom-dead-center position during a compression stroke; and
the mixture is spark ignited at about 40-20° of crank angle before the piston passes through a top-dead-center position during the compression stroke.

15. A method of generating power, comprising:
directing a mixture of gaseous fuel and air into an engine;
combusting the mixture to generate a power output and a flow of exhaust;
drawing energy from the flow of exhaust to compound the power output; and
employing the Miller Cycle when compounding the power output.

16. The method of claim 15, further including:
mixing the gaseous fuel with air; and
drawing energy from the flow of exhaust to pressurize the mixture before directing the mixture into the engine.

17. The method of claim 16, wherein:
the energy drawn from the flow of exhaust to pressurize the mixture is drawn from a location upstream of where energy is drawn from the flow of exhaust to compound the power output; and
the method further includes treating the flow of exhaust at a location downstream of where the energy is drawn from the flow of exhaust to pressurize the mixture and upstream of where the energy is drawn from the flow of exhaust to compound the power output.

18. The method of claim 17, further including spark-igniting the mixture within the engine.

19. The method of claim 17, wherein employing the Miller Cycle includes pushing an amount of the mixture out through an inlet of the engine prior to combustion by closing the intake valve late at a crank angle between about 30-90° after an associated piston passes through a bottom-dead-center position during a compression stroke.

20. The method of claim 19, further including spark igniting the mixture at about 40-20° of crank angle before the piston passes through a top-dead-center position during the compression stroke.

21. The method of claim 17, wherein employing the Miller Cycle includes drawing less air in through an inlet of the engine prior to combustion by closing the intake valve early at a crank angle between about 100-180° after an associated piston passes through a top-dead-center position during an intake stroke.

22. The method of claim 16, wherein the mixture is lean during a majority of an operational time of the engine.
